(19) United States
(12) Patent Application Publication
(10) Pub. No.: US 2011/0010287 A1
(43) Pub. Date: Jan. 13, 2011

(54) SYSTEMS, METHODS AND COMPUTER PROGRAM PRODUCTS FOR REDIRECTING ELECTRONIC TRADE ORDERS

(75) Inventors: Hitesh MITTAL, Edison, NJ (US); Raj JAIN, Princeton, NJ (US)

Correspondence Address: ROTHWELL, FIGG, ERNST & MANBECK, P.C., 1425 K STREET, N.W., SUITE 800, WASHINGTON, DC, 20005, US

(73) Assignee: ITG SOFTWARE SOLUTIONS, INC., Culver City, CA (US)

(21) Appl. No.: 12/834,248

(22) Filed: Jul. 12, 2010

Related U.S. Application Data
(60) Provisional application No. 61/224,579, filed on Jul. 10, 2009.

(51) Int. Cl. G06Q 40/00

(52) U.S. Cl. 705/37

(57) ABSTRACT

A system for redirecting electronic trade orders includes trade order routing facilities coupled with an electronic trade routing network and a plurality of trade venues, including one or more third party broker dealer systems and one or more alternative trading systems. The trade order routing facilities are configured to monitor electronic trade orders at destination trade venues to determine the number of available shares remaining. The trade order routing facilities are further configured to monitor the electronic trade routing network and a plurality of trade venues to identify if any executable trade orders exist that could be matched against some or all of the remaining order portion. Then the trade order routing facilities retrieve some or all of the remaining shares and submit trade orders to execute against the identified orders in other trade venues.

### CROSS-REFERENCE TO RELATED APPLICATIONS

This invention claims the benefit of priority to U.S. Provisional Patent Application No. 61/224,579, filed on Jul. 10, 2009, entitled “Systems, Methods and Computer Program Products for Redirecting Electronic Trade Orders,” the entire contents of which are incorporated herein by reference.

### BACKGROUND OF THE INVENTION

1. Field of the Invention

This invention relates generally to electronic trading of assets. More particularly, the invention relates to systems and methods for routing electronic trade orders to multiple destinations via an electronic trade routing network and for redirecting electronic trade orders from a designated destination to another destination, for execution.

2. Background of the Related Art

Managers of portfolios of assets, such as securities, seek to maximize the value of their portfolios by buying and selling assets therein. Portfolio managers typically work with traders who execute their investment decisions by placing orders to trade (buy or sell) these assets.

Assets can be traded electronically through a number of different trade execution venues (e.g., NYSE, NASDAQ, POSIT®, broker dealers, etc.), which have a variety of different liquidity characteristics. Currently, financial systems exist that assist traders with creating, managing, and routing (i.e., directing) their securities transactions to trade execution venues.

Trading systems exist that allow institutional traders to create and maintain trade orders. For example, Order Management Systems (OMS) are known which perform a number of features including the creation and maintenance data relating to trade orders, compliance, and other investment bookkeeping functions. Execution Management Systems (EMS) are also known. EMS's are another kind of trade tool that include facilities for creating electronic trade orders and execution features that allow traders to transmit trade orders to a plurality of destinations electronically.

Electronic trade routing networks exist that enable various participants in the global electronic securities trading business to send and receive trade orders to and from multiple counterparties. Such networks can be connected to a number of trade execution venues including a number of possible liquidity sources, such as algorithmic trading systems and broker dealers. Such networks may be provided in connection with an EMS, such as ITG's ITG NET^{SM}, which is provided, among other ways, with its EMS Triton® to provide Triton® users consolidated access to multiple broker destinations. Some other examples of electronic trade routing networks include CHARLES RIVER NETWORK, FIDESSA GLOBAL CONNECTIVITY NETWORK, LATENTZERO TRADING NETWORK, LONGVIEW LYNX, NYFIX MARKETPLACE, RADIANZ, SUNGARD TRANSACTION NETWORK, TNS, and TRADEWEB.

Trade orders are often transmitted to sell-side entities (e.g., broker dealers) for execution directly or via electronic trade routing networks. That is, a buy-side institutional trader may manually select a broker destination for a trade order in his or her EMS/OMS, which will then be transmitted to the designated broker destination via the network. Once a broker receives an order, it will typically use any and all means available to execute the trade order while maximizing gain to the broker.

Traders may also use algorithmic trading systems that utilize models and strategies to provide traders the best possible execution price while trying to reduce market impact. Institutional traders, i.e., buy-side traders who execute large volume orders, often employ algorithmic trading systems to slice and dice large block orders into smaller, more easily executed orders that may be transacted throughout a trading day or even over a longer period.

Operators of electronic trade routing networks allow trade orders to flow passively through their systems to the trading venue designated by the trader. This represents a liquidity source that is currently untapped.

### SUMMARY OF THE INVENTION

An object of the present invention is to provide systems and methods for operators of electronic trade routing networks to treat liquidity within the network in an aggregated fashion by proactively adjusting orders sent into the network and redirecting all or part of such orders to destinations where additional liquidity may exist, thereby simultaneously increasing executions and improving execution rates for the trader client.

According to embodiments of the present invention, an electronic trade routing network is configured to transmit electronic trade orders from buy-side traders with multiple brokers. Systems and methods are provided for retrieving part or all of an electronic trade order placed with a broker via the network back from the broker and for redirecting the retrieved portion to another broker via the network, on the trader's behalf. According to an embodiment of the present invention, systems and methods are provided for monitoring liquidity (e.g., electronic trade orders) passing through the network to identify potential matches or contra-orders within the network or in other destinations. When such matches are identified, trade orders are seamlessly rerouted in order to effect a trade without any impact to the buy-side trader's workflow.

According to embodiments of the present invention, a method is provided for redirecting trade order flow in an electronic trade routing network to cross the flow with other trade orders within the network with other liquidity sources attached to the network.

According to embodiments of the present invention, a system is configured to take an order, or part of an order, sent to a destination via a broker network and cross it somewhere else in the network, according to trader preferences.

According to an embodiment of the present invention, an electronic trade routing system for transmitting electronic trade orders from traders amongst electronic trade execution venues, includes an electronic trading network electronically coupled with a plurality of trading clients and with the electronic trade execution venues. The electronic trading network is configured to receive electronic trade orders from the clients and to route the electronic trade orders to one or more electronic trade execution venues, and to receive execution data relating to trade executions from the execution venues, wherein the electronic trade orders each have at least one identified destination electronic trade execution venue. The system also includes an order monitoring server coupled with the electronic trading network and configured to monitor received electronic trade orders passing through the network, for one or more of the received electronic trade orders, to identify potential contra-orders at an electronic trade execution venue other than the respective identified destination electronic trade execution venue and, when a contra-order is identified, to reroute at least a portion of the respective electronic trade order to effect a trade with the identified contra-order.

According to an embodiment of the present invention, a system includes an electronic trade routing network for routing electronic trade orders received from a trader to a designated destination. The network includes trader order routing facilities that are coupled with a plurality of trade venues including one or more third party broker dealer systems and one or more alternative trading systems. The trader order routing facilities are configured to receive an electronic order to trade a tradeable asset from a trader, identify the trade venue that is the designated destination of the order, and electronically route the order to the designated destination trade venue as a first trade order. The trader order routing facilities are also configured to monitor the electronic trade order at the designated destination trade venue to determine the number of shares that have been executed at the designated destination trade venue for the order, and thereby, the number of available shares remaining. The trader order routing facilities are further configured to monitor the electronic trade routing network and a plurality of trade venues to identify if any executable trade orders exist that could be matched against some or all of the remaining portion of the first electronic trade order. If one or more executable trade orders are identified to exist in trade order venues other than the designated destination trade order venue, then the trader order routing facilities are further configured to redirect (i.e., retrieve shares and transmit a new order) some or all of the remaining shares of the first trade order from the destination trade venue to execute against the one or more executable trade orders identified to exist in other trade venues.

According to an embodiment of the present invention, when a portion of an order is redirected from the designated destination, the original order transmitted to the designated destination can be cancelled and replaced with a new order decreased in quantity corresponding to the portion redirected.

According to one embodiment of the present invention, the system is coupled with one or more alternative trade systems, and the trader order routing facilities are configured to redirect shares from the first trade order when one or more executable trade orders are identified to exist in the one or more alternative trade systems.

According to one embodiment of the present invention, the first electronic trade order includes a field or identification that the order can be exposed to trade venues other than the destination trade venue.

According to one embodiment of the present invention, the first electronic trade order includes a field or identification that the order can be exposed to internal trade venues. Alternatively, all orders can be exposed or orders by client, broker or other designation can be exposed.

According to an embodiment of the present invention, a method for crossing an electronic trade order is provided. The method includes a step of receiving an electronic trade order at a electronic trade routing network, identifying the trade venue that is the electronic destination of the trade order, and electronically transmitting to the identified destination a first electronic trade order corresponding to the received trade order. The trade order may include an identification of the commodity to be traded, of a quantity to be traded, of the side of the trade (i.e., BUY or SELL), of the destination, and of whether the order can be exposed to destinations other than the identified destination. If the trade order includes an indication that it can be exposed to destinations other than the identified destination, then other destinations are monitored to identify executable trade orders that are a potential match to the received order. If one or more orders are identified as potential matches for the received order, then the quantity available in the one or more potential matching orders is determined, that same amount is recovered from the first electronic trade order, and one or more second trade orders are transmitted to the respective destinations of the other destinations corresponding to the one or more potential matching orders. Accordingly, trade orders can be redirected, in whole or in part, from one destination to another within the electronic trade routing network.

According to an embodiment of the present invention, a computer implemented method can include a step of receiving a first electronic trade order from a trader at an electronic trade routing network. The destination trade venue of the trade order is identified from the first electronic trade order. A second electronic trade order corresponding to the received trade order is transmitted by the network to the destination. One or more other trade venues are monitored. If a contra-order in the one or more second trade venues is identified that can be matched against some or all of the first electronic trade order, then a portion of the first electronic trade order corresponding to the contra-order is recovered from the original destination (e.g., by canceling and replacing the second trade order), and a third electronic trade order having a same size as the contra-order is transmitted by the network to the one or more second trade venues where the contra-order is located to be matched against said contra-order.

In some embodiments, first electronic trade order can include an identification of: the commodity to be traded, a quantity to be traded, the side of the trade (i.e., BUY or SELL), the destination, and whether the order can be exposed to destinations other than the identified destination; and the monitoring step is only performed if the trade order includes an indication that it can be exposed to destinations other than the identified destination.

According to some embodiments, a contra-order is identified within the network and all or some of the first order is crossed with the contra-order within the network itself or with a third party.

According to another embodiment, a computer implemented method is provided for routing an electronic trade order. The method includes a step of receiving at an electronic trading network, a first electronic trade order from a trader. The method further includes a step of, at the electronic trading network, routing the first electronic trade order to the electronic trade destination designated by the trader. Also, a step is provided for monitoring, at a computer, the electronic trading network for potential contra-orders to the first electronic trade order. Also a step is provide for identifying, at the computer, a contra-order within the electronic trading network that can be matched with the first electronic trade order. The contra-order has a quantity less than or equal to a quantity of the first electronic trade order. The method further includes a step of replacing the first electronic trade order with a second electronic trade order having a quantity equal to the difference in quantity between the quantity of the first electronic trade order and the quantity of the contra-order. An electronic trade order having a quantity equal to the contra-order is transmitted to an electronic trading venue.

According to some embodiments, the first electronic trade order is sent directly from the trader to the electronic trade destination designated by the trader. In these embodiments, an order is not created at the network. The steps of monitoring, identifying, replacing and transmitting are performed all the same.

Other objects, advantages and features of the invention that may become hereinafter apparent, the nature of the invention may be more clearly understood by reference to the following detailed description of the invention, the appended claims, and the drawings attached hereto.

### BRIEF DESCRIPTION OF THE DRAWINGS

FIG. 1 is a block diagram of an exemplary trading system according to aspects of the present invention.

FIG. 2 is a block diagram of an exemplary electronic trade order router system according to aspects of the present invention.

FIGS. 3A-3F illustrate of an exemplary routing process, according to the present invention.

FIGS. 4A-4C illustrate a second exemplary routing process, according to the present invention system.

FIGS. 5A-5C illustrates a third exemplary routing process, according to an embodiment of the present invention.

### DETAILED DESCRIPTION OF THE INVENTION

The current invention relates to redirecting electronic trade orders to buy or sell tradeable assets, such as commodities including securities, within electronic trade routing networks (sometimes called “broker networks”), in order to improve execution rates for a trader client (e.g., buy-side institutional trader) and increase liquidity within a given electronic trading venue.

The use of the terms “assets,” “commodities,” “securities,” etc. are not meant to limit the present invention and one of ordinary skill in the art would recognize that the invention will be application to many aspects of electronic trading, including the trading of securities, futures, currency, and many other known instruments.

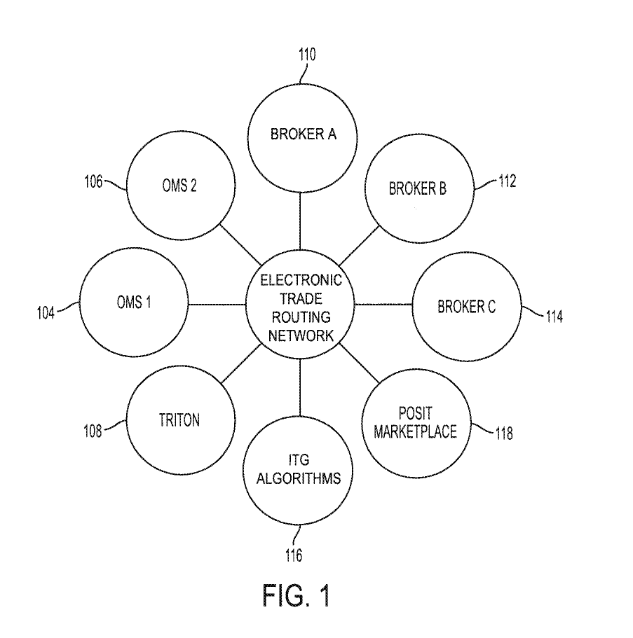

FIG. 1 is a high-level block diagram illustrating a system according to an embodiment of the present invention. System 100 may include electronic trade routing network 102 electronically coupled with or in communication with a plurality of trader desktops 104-108, external trade venues 110-114, and internal liquidity sources 116-118.

Trader desktops 104-108 may include client desktop computers executing order management systems (OMS) 104-106 and/or execution management systems (EMS) 108, which are coupled with an electronic data network and configured to create and transmit electronic trade orders to trade venues via the electronic trade routing network 102. For example, a number of electronic trade routing networks currently exist, such as ITG NET^{SM}, CHARLES RIVER NETWORK, FIDESSA GLOBAL CONNECTIVITY NETWORK, LATENTZERO TRADING NETWORK, LONGVIEW LYNX, NYFIX MARKETPLACE, RADIANZ, SUNGARD TRANSACTION NETWORK, TNS, and TRADEWEB. The trade desktops 104-106 can be in communication with the network 102 via a public or proprietary data network and/or through protocols or common protocols, such as the financial exchange (FIX) protocol.

The external trade venues 110-114 can include any number of trade venues, such as those provide by broker-dealers, for example, as MORGAN STANLEY or CREDIT SUISSE. Trade venue refers to any type of marketplace, exchange, broker or other destination where orders to trade securities can be executed. Electronic trade routing network 102 may be directly coupled to and/or configured to communicate with the external trade venues 110-114 to submit electronic trade orders thereto, such as via FIX, and to cancel or modify such electronic trade orders, and to receive information back from the external venues, such as execution information or status information. Electronic trade routing network 102 may also be configured to transmit execution information (sometimes called “fill” data) that it receives as a result of trades executed, back to the trade desktops 104-108. Accordingly, electronic trade routing network 102 may include storage and communication facilities for performing these functions.

Internal liquidity sources 116-118 can include streaming liquidity sources such as algorithmic trade systems 116 and other trade venues, such as alternative trading systems (ATS) 118, e.g., ITG's POSIT Marketplace™. Network 102 may be configured to receive data relating to executable trade orders or other liquidity (e.g., conditional orders or indications of interest) from the internal liquidity sources 114-116.

While liquidity sources 110-114 are denoted as “external” and liquidity sources 116-118 are denoted “internal,” the present invention is not meant to be limited to internal or external sources. The labels “external” and “internal” only refer to an exemplary embodiment wherein the operator of the electronic trading network 102 also operates (e.g., owns, operates via a joint venture or partnership, etc.) liquidity sources, such as an ATS or algorithmic trade system. As will be apparent from the description below, the present invention is not limited to such an arrangement and can be used to redirect trade orders within an electronic trading network from one liquidity source to another without regard to whether the liquidity source is external or internal to the operator of the liquidity source. In fact, the operator of the network need not own or operate any liquidity source.

In fact, as should be apparent from this document, the orders may be redirected from one broker or venue to another broker or venue without the operation of a network. That is, as described in further detail below, trade forums may be monitored for liquidity and orders in one forum may be adjusted down in order so that part or all of the order may be sent to another forum where liquidity is determined to exist.

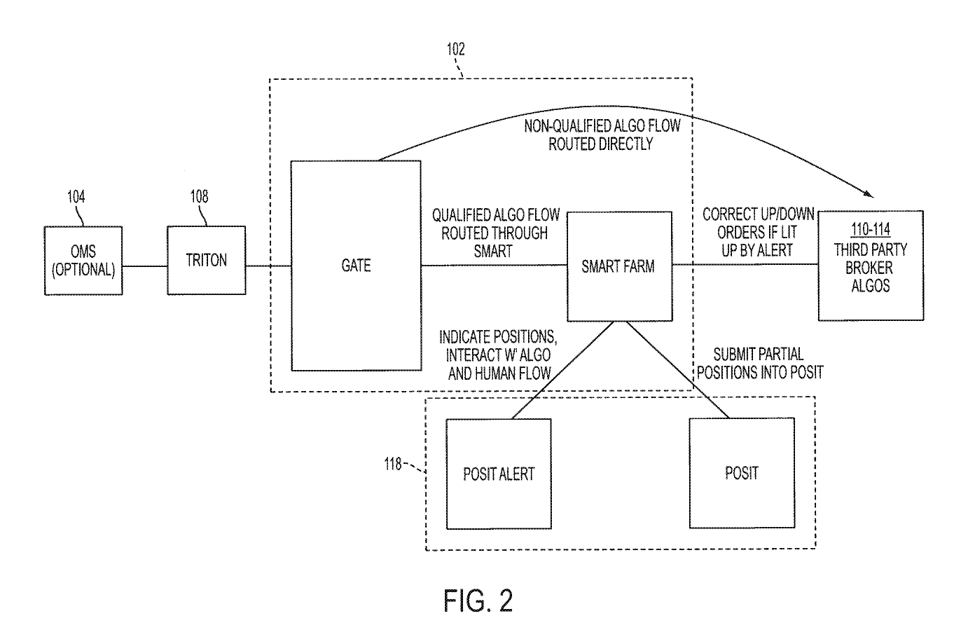

The general operation of the system will be described with reference to FIG. 2, which illustrates a detailed logic diagram of a trading system, including exemplary electronic trade order flow, according to an embodiment of the present invention.

As shown, a trader can create an executable trade order in an OMS 104 or EMS 108 and designate the destination for that electronic trade order. Also, the OMS 104 can be coupled with an EMS 108, such as MACGREGOR'S XIP OMS can be coupled with ITG's TRITON EMS.

The electronic trade order can be transmitted to the electronic trade routing network 102 via an electronic data network (not shown) and received by the electronic trade routing network 102 via a gateway (gate) 102a, which is configured to receive and send information to and from the electronic trade routing network 102. Gate 102a may be configured to convert information received into a protocol for use internally within electronic trade routing network 102 and to likewise convert information from the internal protocol to the appropriate protocol for transmission to another system, such as the OMS 104, EMS 108 or external trade venues 110-114.

The electronic trade order will include an identification of the trade venue that is the designated destination for the trade order. For example, a field could be provided in the trade order data for the destination. The trader may select the destination or a default destination could be provided. As an example, FIX protocol could be used, which provides for the inclusion of certain information in a trade order, including destination ID. The destination could be a market, alternative trade system (ATS), electronic communication network (ECN), broker dealer, algorithmic trading destination, etc.

If the electronic trade order received from the trader includes an external destination and there is an indication that the order should only be directed to that destination, then the trade order can be directly routed to that destination by gate 102a as shown. As an example, ITG's TRITON may be configured to allow a trader to send algorithmic trade orders to third party broker algorithmic trading systems, such as GOLDMAN SACHS' SIGMA X. If the trade order is non-qualified, meaning that it will not be exposed to any other liquidity sources other than the designated destination (e.g., SIGMA X), then gate 102a converts the trade order to the format required by the destination, if necessary, and electronically transmits the order to that destination in the proper format.

If, however, the trade order is qualified with an indication that it can be exposed to other liquidity sources (e.g., switched or redirected from one broker to another broker), then the trade order is exposed to internal liquidity sources by order-router 102. For example, as shown, the received order can be converted to an internal protocol and provided to a smart routing server 102b, that is coupled with a plurality of internal liquidity sources 118a and 118b. Preferably, the order information is not shared with the internal liquidity sources unless contra-orders exist for the electronic trade order.

Although, as shown, the smart router server 102b is directly coupled with the external liquidity sources 110-114, such trade orders will typically go through gate 102a or another gateway. In order to perform its functions, smart router server 102b can include hardware and software for caching data relating to received and transmitted electronic trade orders, for communicating with internal liquidity sources, for generating indications of interest and firm trade orders, including modifications and cancellations.

The electronic trade routing network 102 can cache the data relating to the trade order received from the trade OMS/EMS as the “parent.” If electronic trade routing network 102 creates electronic trade orders based on the parent order, these additional related orders are considered to be suborders or “child” trade orders. As shown, a suborder for the entire quantity is created by the electronic trade routing network 102 and sent to the designated destination. By creating the parent-child relationship, control of the trade order is kept in the electronic trade routing network 102.

Electronic trade routing network 102 can keep track of the available quantity by monitoring the execution data that it receives from the designated destination as the order is worked at that destination. The smart router server 102b can be configured to correct the orders sent to the original designated destination up or down in order open up liquidity to match against liquidity found in the internal sources. Electronic trade routing network 102 can also configured to monitor the other liquidity sources to identify potential matches for the order outside of the original destination. If potential matches exist in another liquidity source outside the original destination, the electronic trade routing network 102 can recover the amount (quality of shares) that can be matched (e.g., by submitting a cancel-and-replace order to the original destination) and can create and transmit corresponding child orders to the other liquidity source(s) for execution. Accordingly, trade orders can be redirected within or outside the network.

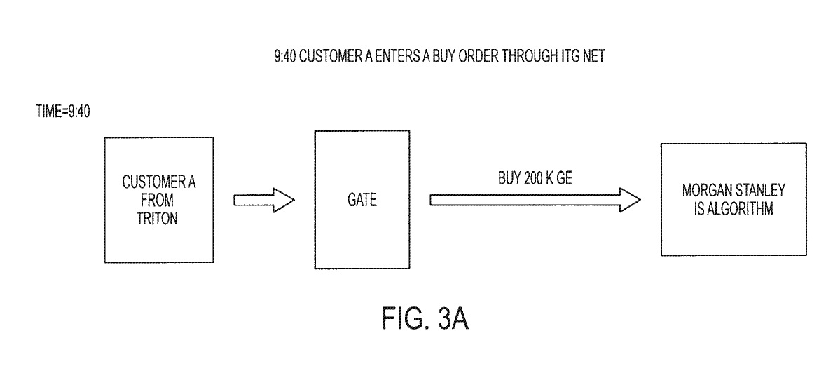

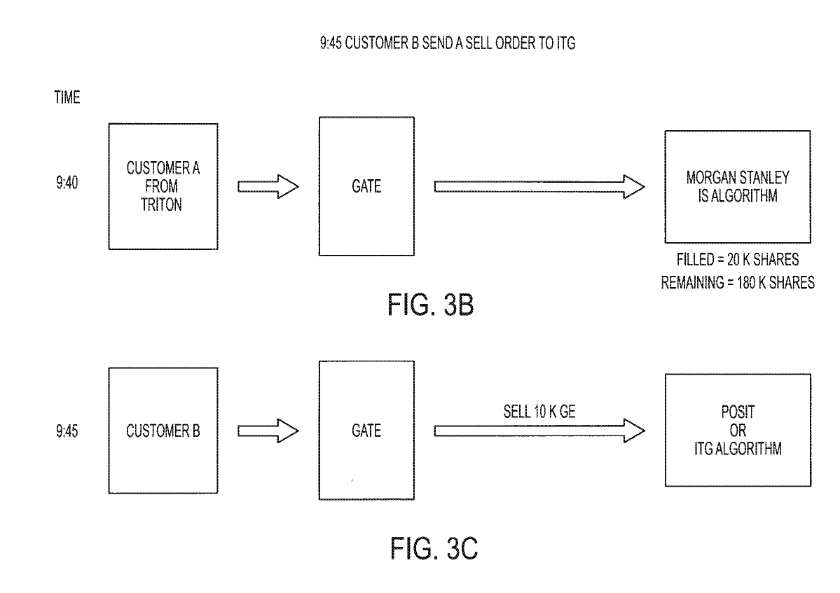

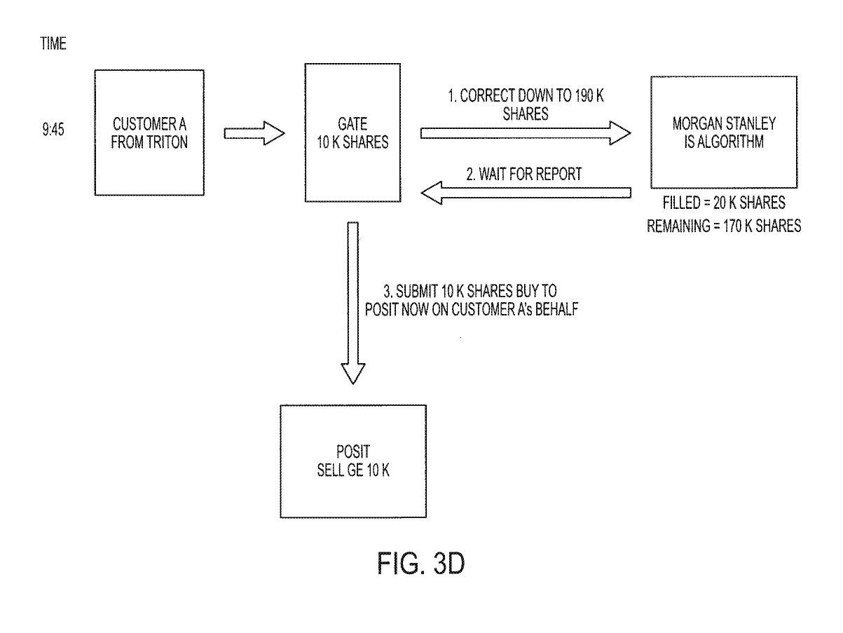

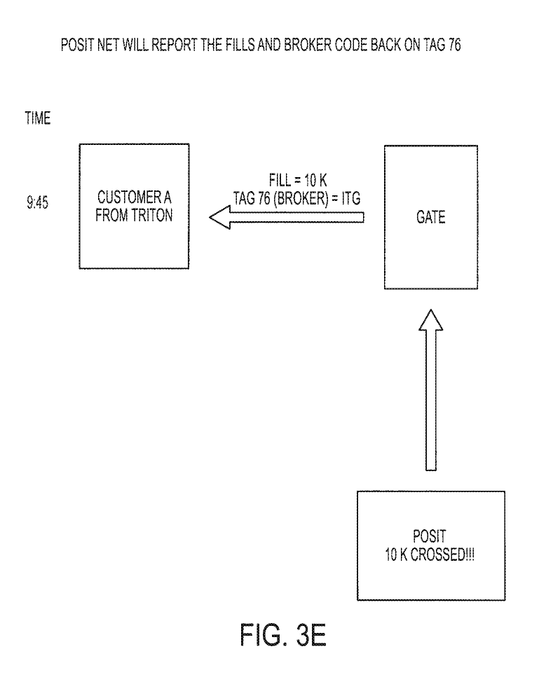

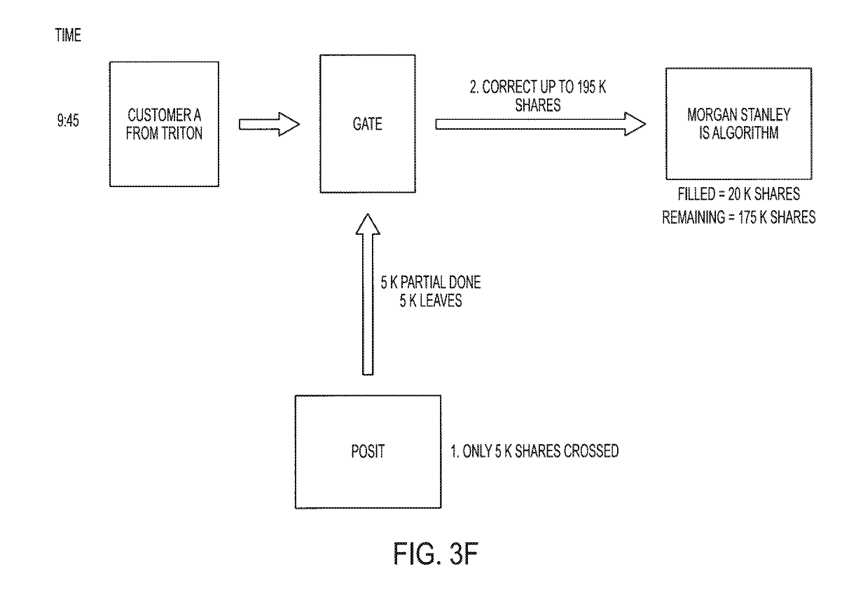

An exemplary process according to an embodiment of the present invention is next explained with reference to FIGS. 3A-3F. First, as shown in FIG. 3A, a customer enters a trade order (BUY 20,000 GE) at time 9:40 in an EMS such as ITG's TRITON. The electronic trade order is transmitted to the Gate, which forwards the electronic order to the designated destination, in this example, the MORGAN STANLEY IS algorithm. By forward, it is meant that the trade order may be forwarded, a copy could be sent, or preferably, suborders could be sent as described above.

As shown in FIG. 3B, the MORGAN STANLEY IS algorithm fills 20,000 shares of the trade order. As already described above, the execution data can be monitored by the network (which transmits the fill data back to the EMS) so that the quantity of shares remaining can be determined—in this case 180,000 shares.

In FIG. 3C, a second customer (Customer B) submits an electronic trade order to another liquidity sources (e.g., POSIT NOW or an ITG algorithm) at 9:45 am to SELL 10,000 shares of GE.

As shown in FIG. 3D, upon identifying the SELL order in POSIT, the original order sent to MORGAN STANLEY can be corrected DOWN from 200,000 to 190,000, thereby reducing the remaining shares from 180,000 to 170,000 and recovering 10,000 shares internally into the network to be redirected. As shown, in response, MORGAN STANLEY will generate a report once the correction has been made confirming that 10,000 shares are returned. A BUY order for 10,000 shares can then be submitted to POSIT to be matched with the SELL order that has been identified as standing there.

As shown in FIG. 3E, the contra-orders are crossed and the execution data is routed back to the originating trade system, which in this case was Triton®. Also as shown, the broker will be identified as the owner of the ATS where the cross occurred (in this case ITG), not the original destination. Thus, a portion of the original trade order has been transferred, in this case, from the originally designated broker (MORGAN STANLEY) to another broker (ITG) in order to achieve a trade for the trader and without any change in the trader's workflow.

FIG. 3F shows another scenario wherein after the order to BUY 10,000 shares of GE is sent to POSIT, only a partial fill occurs in POSIT. This could occur because in the time that it took to recover the 10,000 shares inside POSIT, the SELL order could have crossed with 5,000 shares relating to another BUY order. In this case, when it is identified that only 5,000 shares were crossed in POSIT, the original order to the MORGAN STANLEY IS algorithm can be corrected up to 195,000 shares from the 190,000 shares thereby making 175,000 shares of GE remaining in the order with MORGAN STANLEY. Thus, all shares remaining are kept with the original designated destination.

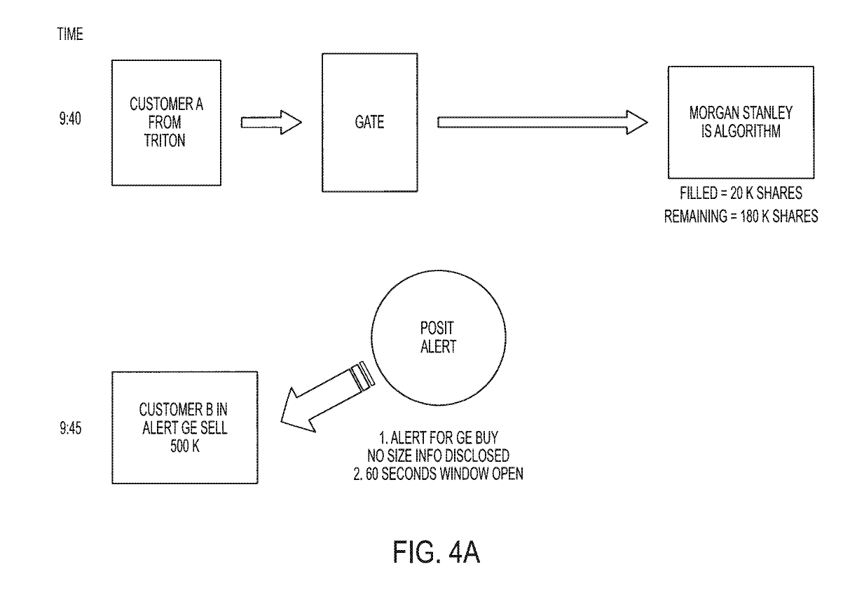

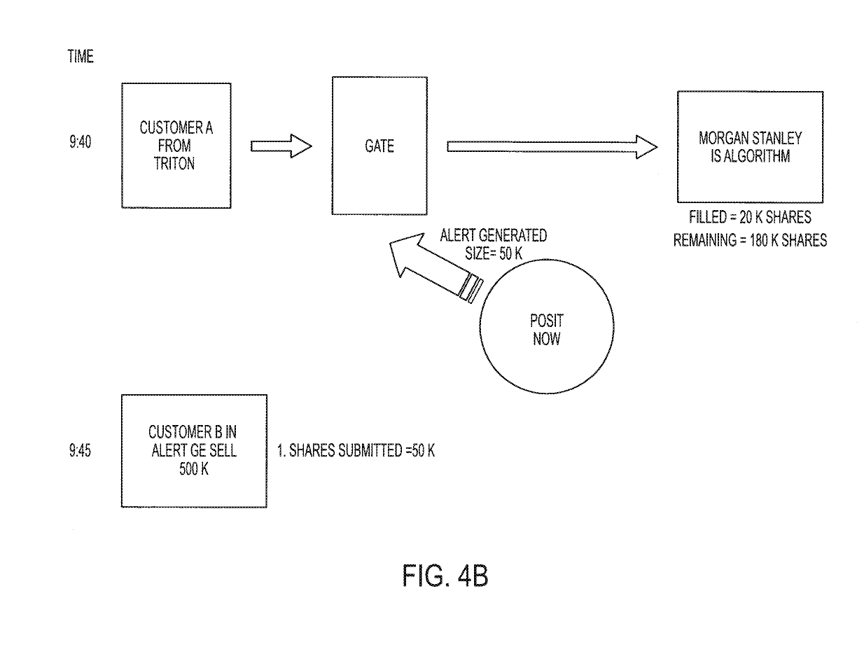

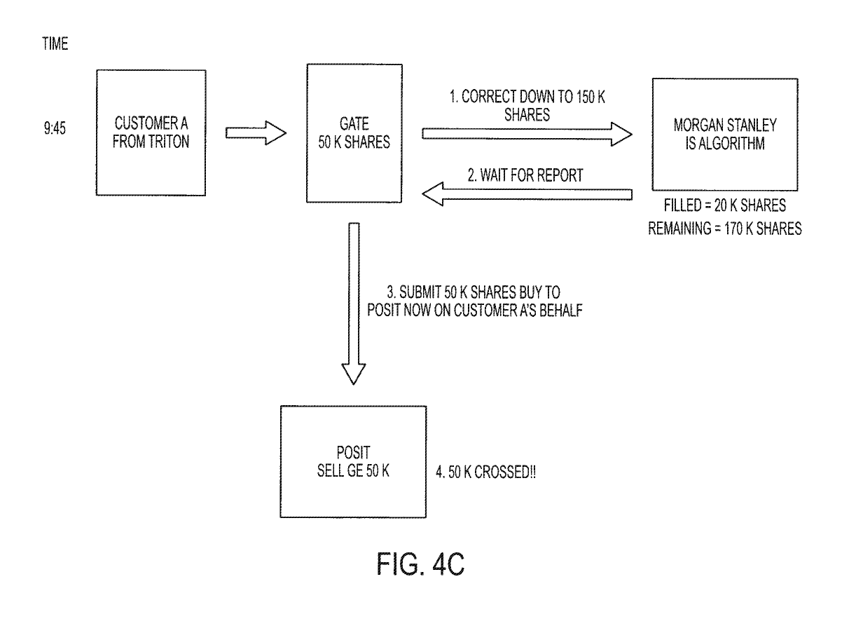

A second example is described next with reference to FIGS. 4A-4C. As shown in FIG. 4A, Customer A submits an order to BUY 200,000 shares of GE to the MORGAN STANLEY IS algorithm, which has already filled 20,000 shares of the order at time 9:40. At time 9:45, a Customer B has an indication of interest (IOI) in to the POSIT ALERT system for a SELL order of 500,000 shares for GE. The IOI is non-binding and represents liquidity of Customer B.

Once this SELL indication is identified by the system, an “alert” or IOI can be transmitted to Customer B with no size information disclosed, and to solicit a firm order from for Customer B. An exemplary IOI based trading system is described in co-owned U.S. patent application Ser. No. 11/259,363, entitled SYSTEM AND METHOD FOR GENERATING LIQUIDITY and filed on Oct. 27, 2005; the entire contents of which are incorporated herein by reference.

As shown in FIG. 4B, Customer B submits in response to the alert, 50,000 shares into the POSIT. Similar to the example of FIG. 3, the original order to MORGAN STANLEY can be corrected DOWN by 50,000 shares and an order (child) to BUY 50,000 shares of GE can be sent to POSIT to match with the SELL order from Customer B. As illustrated in FIG. 4C, 50,000 will be crossed.

With respect to IOIs, alerts can be sent to all participants. However, size information will preferably only be disclosed to an algorithm or system destination and not to human participants. If one of the participants is a human, then size information will not be disclosed since there is a fair chance that there will be a no trade event in order to prevent leakage. It is important to wait for a human to submit an order before size information is disclosed. At the point that the size information is available, it can then be used.

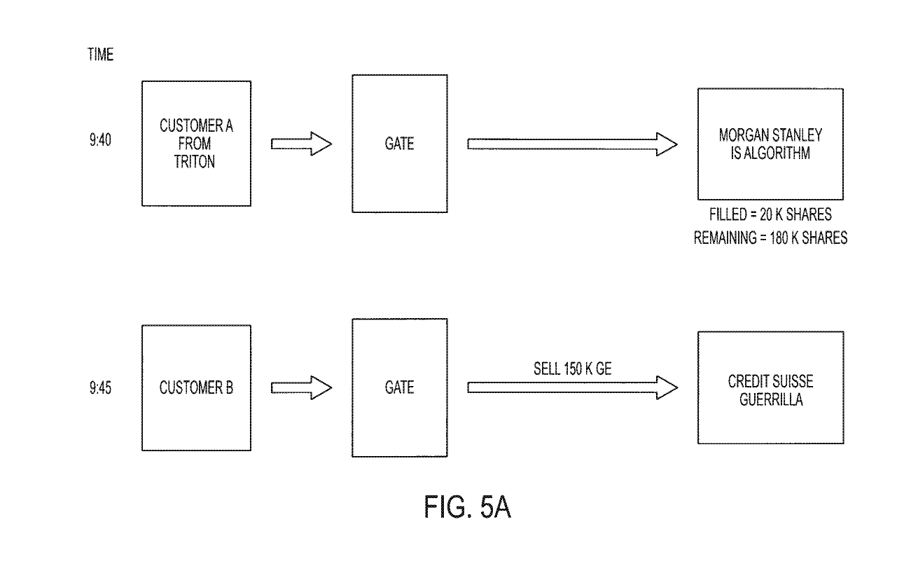

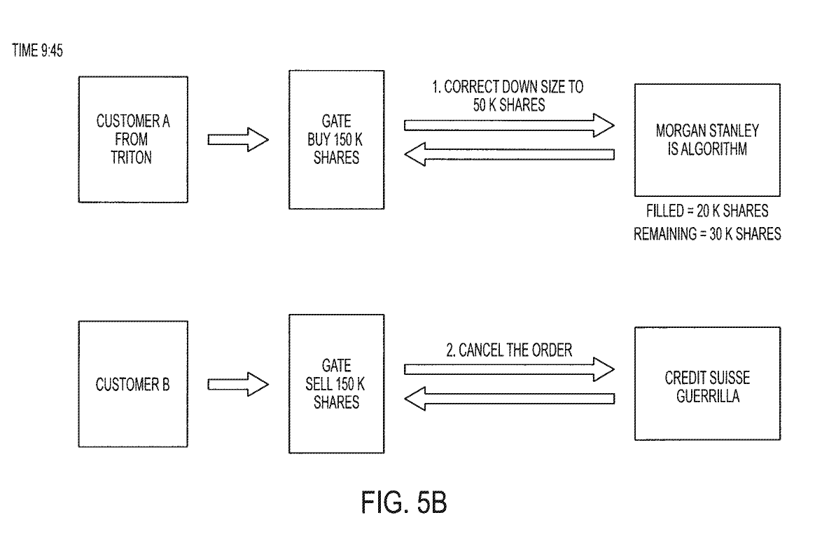

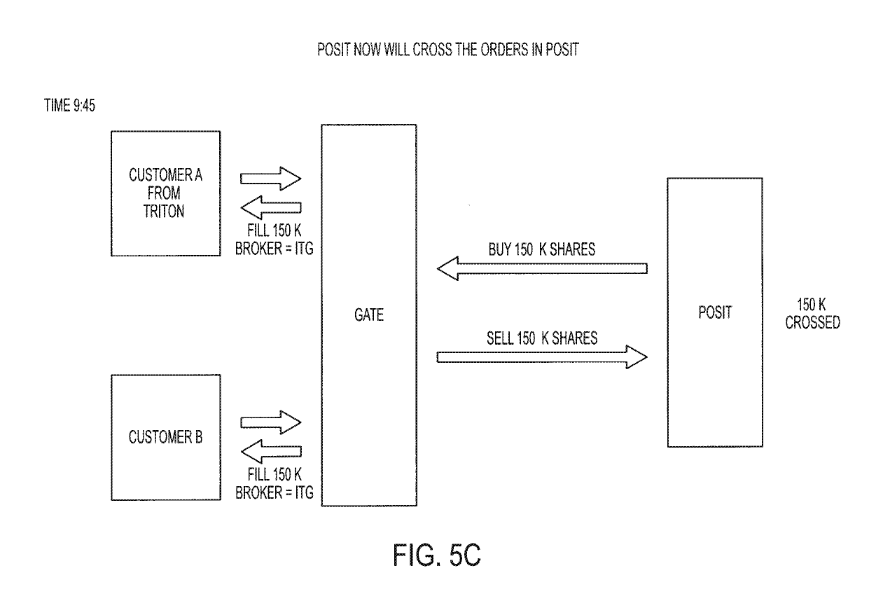

A third example is illustrated in reference FIGS. 5A-5C. In this example, a true internal cross is effected. As shown in FIG. 5A, a first Customer A transmits an order to MORGAN STANLEY IS algorithm to BUY 200,000 shares of GE. At time 9:40, the IS algorithm has already filled 20,000 shares and 180,000 shares now remain. At time 9:45, a second Customer B transmits a SELL order to SELL 150,000 shares of GE to a second algorithm, e.g., CREDIT SUISSE GUERRILLA. Since both of these orders have come through the network, there is knowledge about a potential match and as shown in FIG. 5B, the first order can be corrected down 150,000 shares to 50,000 shares thereby leaving 30,000 shares remaining with the MORGAN STANLEY IS algorithm. Likewise, the second order can be corrected down to zero (e.g., the order to GUERRILLA can be cancelled). As shown in FIG. 5C, a 150,000 BUY order and a 150,000 SELL order can now be generated and sent to an internal ATS (e.g., POSIT) in order to be crossed internally.

Thus, as described and illustrated above, the order routing system of the present invention can be used to internalize liquidity destined for external trade venues in order to maximize liquidity in internal trade venues. Further, the system is capable of leveraging both internally bound and externally bound orders as well as indications in an internal trade venue such as an IOI based system or crossing network. Finally, orders bound for separate external trade venues can be identified as a match and redirected according to the present invention.

According to an embodiment of the present invention, an “opt-in” model could be used for traders utilizing the present invention. Accordingly, traders that would like to expose their orders to liquidity sources other than the chosen destination can be provided with a means for indicating so at the time of creating the trade order. For example, an extra field could be provided in their OMS or EMS for opting in. Further, the opt-in procedure could include an identification of the number of shares that could be exposed to internal liquidity sources as well as the kind of liquidity sources to be exposed (e.g., standing order flow only, standing order flow and human water flow, etc.).

In some embodiments, the exposure of trade orders to liquidity sources other than the designated destination and/or the redirecting of trade orders as described above may be provided automatically or defaulted to be provided automatically. Thus, traders would only need to note which trades are not to be exposed or redirected, or could set the default off or to manual selection.

Various embodiments of the current invention could be implemented using a combination of both hardware and software components. For example, embodiments of the current invention could be implemented using amalgamation of various hardware systems connected over LAN or WAN. The system compromises of following hardware configurations but not limited to x64-based or x86-based multi-core CPU, Windows 2000 Server, Windows 2003 Server, Red Hat Linux or SUN Solaris as an operating system running on HP System Model ProLiant BL460c G6, Sun Fire x4170, Sun Fire x4450, Sun Fire x4600 and Sun Fire x4100 with Intel Xeon e5450 8 core 3 Ghz (or equivalent CPU), 32 GB RAM, 500 GB HDD, Curtis 6 GB SSD, 4 Network Interface cards of 1 GB capacity, a graphic card, Input/Output devices (e.g. mouse, keyboard, monitor), external storage devices NetApp FAS 3070 running on onTap 7.3.2, Database Systems MS SQL Server 2008, Sybase ASE, Oracle 11 g and MySQL. The hardware system will be linked over LAN and WAN using Fast Ethernet switches or equivalent.

Thus, the present invention has been fully described with reference to the drawing figures. According to aspects of the present invention, systems and methods have been provided by which electronic trade orders can be exposed to multiple liquidity sources without any change in the work flow for the trader or the destinations.

Although the invention has been described based upon these preferred and exemplary embodiments, it would be apparent to those of skilled in the art that certain modifications, variations, and alternative constructions would be apparent, while remaining within the spirit and scope of the invention. In order to determine the metes and bounds of the invention, therefore, reference should be made to the appended claims.

We claim:

1. An electronic trade routing system for transmitting electronic trade orders from traders amongst a plurality of electronic trade execution venues, comprising:
an electronic trading network coupled with a plurality of trading clients and with said plurality of electronic trade execution venues, and configured to receive electronic trade orders from said clients and to route said electronic trade orders to one or more electronic trade execution venues, and to receive execution data relating to trade executions from said trade execution venues, wherein said electronic trade orders each have at least one identified destination electronic trade execution venue;
an order monitoring server coupled with said electronic trading network and configured to monitor received electronic trade orders being routed through the electronic trading network, for one or more of said received electronic trade orders, to identify potential contra-orders at an electronic trade execution venue other than the respective identified destination electronic trade execution venue and, when a contra-order is identified, to recover and reroute at least a portion of the respective electronic trade order to effect a trade with the identified contra-order.

2. The electronic trade routing system according to claim 1, further comprising an electronic trade execution matching system for matching electronic trade orders, and executing and recording trades based on the matching electronic trade orders;
wherein said order monitoring server is further configured to identify matching contra-orders among said received electronic trade orders and to route said matching contra-orders to said electronic trade execution means.

3. The electronic trade routing system according to claim 1, further comprising a smart router configured to receive electronic trade orders and market data regarding said electronic trade execution venues, and based upon the contents of the electronic trade orders and upon said market data, select optimal destinations from said electronic trade execution venues for said electronic trade orders.

4. The electronic trade routing system according to claim 1, wherein said electronic trade routing system is configured to cancel at least part of an electronic trade order sent to one of said electronic trade execution venues and to send a new electronic trade order based on the cancelled at least part.

5. The electronic trade routing system according to claim 1, wherein said electronic trade orders include information identifying a tradeable asset, the side of the trade (buy or sell), a quantity to be bought or sold, and a destination to be sent.

6. The electronic trade routing system according to claim 2, wherein said electronic trade orders include information identifying a tradeable asset, the side of the trade (buy or sell), and a quantity to be bought or sold;
wherein the destination of the order is the one or more destinations selected by said smart router.

7. The electronic trade routing system according to claim 1, wherein the trading clients include one or more from a list consisting of order management systems, execution management systems, and proprietary trading interfaces.

8. The electronic trade routing system according to claim 1, wherein the trade execution venues include one or more from a list consisting of alternative trade system, electronic communication networks, markets, algorithmic trading systems, streaming liquidity systems, negotiated trading systems, and crossing systems.

9. The electronic trade routing system according to claim 5, wherein said electronic trade orders further includes an indication whether the order is qualified for rerouting and wherein said electronic trade routing system is configure only to reroute electronic trade orders that bear an indication that the order is qualified for rerouting.

10. The electronic trade routing system according to claim 1, wherein when said order monitoring server determines that at least a portion of an electronic trade order already routed should be redirected from the designated destination to a new destination, the original electronic trade order transmitted to the designated destination is cancelled and replaced with a new electronic trade order decreased in quantity corresponding to the portion being redirected.

11. A computer-implemented method for executing an electronic trade order, comprising:
a step of receiving from one or more electronic trade clients, one or more electronic trade orders at a electronic trade routing network;
identifying a destination trade venue that is the electronic destination of the trade order;
electronically transmitting to the destination trade venue a first electronic trade order corresponding to the received trade order;
monitoring a plurality of electronic trade venues to identify executable trade orders that are a potential match to the received order;
if one or more orders are identified as potential matches for the received order, determining an available quantity in the one or more potential matching orders;
recovering at least a portion of the first electronic trade order.

12. The method according to claim 11, further comprising a step of identifying matching contra-orders among said received electronic trade orders and executing said contra-orders without routing the contra-orders to their designated destinations.

13. The method according to claim 11, further comprising a step of, based upon the contents of the electronic trade orders and upon market data, selecting optimal destinations from said electronic trade execution venues for said electronic trade orders.

14. The method according to claim 11, wherein said step of recovering includes canceling at least part of an electronic trade order sent to one of said electronic trade execution venues.

15. The method according to claim 11, wherein said electronic trade orders include information identifying a tradeable asset, the side of the trade (buy or sell), a quantity to be bought or sold, and a destination to be sent.

16. The method according to claim 12, wherein said electronic trade orders include information identifying a tradeable asset, the side of the trade (buy or sell), and a quantity to be bought or sold;
wherein the destination of the order is the one or more optimum destinations selected.

17. The method according to claim 11, wherein the electronic trade clients include one or more from a list consisting of order management systems, execution management systems, and proprietary trading interfaces.

18. The method according to claim 11, wherein the trade execution venues include one or more from a list consisting of alternative trade system, electronic communication networks, markets, algorithmic trading systems, streaming liquidity systems, negotiated trading systems, and crossing systems.

19. The method according to claim 15, wherein said electronic trade orders further includes an indication whether the order is qualified for rerouting and wherein only electronic trade orders that bear an indication that the order is qualified for rerouting are rerouted.

20. The method according to claim 11, wherein when it is determined that at least a portion of an electronic trade order already routed should be redirected from the designated destination to a new destination, the original electronic trade order transmitted to the designated destination is cancelled and replaced with a new electronic trade order decreased in quantity corresponding to the portion being redirected.

21. The method according to claim 11, wherein the monitoring step is performed only when the trade order includes an indication that it can be exposed to destinations other than the destination trade venue.

22. The method according to claim 11, wherein in the recovering step, the recovered portion is equal to or less than the determined amount available.

23. The method according to claim 11, further comprising a step of transmitting one or more second trade orders to the respective destinations of corresponding to the one or more potential matching orders, said one more second trade orders corresponding to the recovered amount of the first electronic trade order.

24. An electronic trade routing system for transmitting electronic trade orders from traders amongst electronic trade execution venues, comprising:
means for electronically coupled with a plurality of trading clients and with said electronic trade execution venues;
means for receiving electronic trade orders from said clients and routing said electronic trade orders to one or more electronic trade execution venues;
means for receiving execution data relating to trade executions from said execution venues, wherein said electronic trade orders each have at least one identified destination electronic trade execution venue;
means for monitoring received electronic trade orders, for one or more of said received electronic trade orders, identifying potential contra-orders at an electronic trade execution venue other than the respective identified destination electronic trade execution venue and, when a contra-order is identified, rerouting at least a portion of the respective electronic trade order to effect a trade with the identified contra-order.

25. The electronic trade routing system according to claim 24, further comprising electronic trade execution matching means for matching electronic trade orders and executing and recording trades based on the matching electronic trade orders;
wherein the system identifies matching contra-orders among said received electronic trade orders and routes said matching contra-orders to said electronic trade execution means.

26. The electronic trade routing system according to claim 24, further comprising smart router means for receiving electronic trade orders and market data regarding said electronic trade execution venues, and based upon the contents of the electronic trade orders and upon said market data, selecting optimal destinations from said electronic trade execution venues for said electronic trade orders.

27. The electronic trade routing system according to claim 24, wherein said system cancels at least part of an electronic trade order sent to one of said electronic trade execution venues and sends a new electronic trade order based on the cancelled at least part.

28. The electronic trade routing system according to claim 24, wherein said electronic trade orders include information identifying a tradeable asset, the side of the trade (buy or sell), a quantity to be bought or sold, and a destination to be sent.

29. The electronic trade routing system according to claim 25, wherein said electronic trade orders include information identifying a tradeable asset, the side of the trade (buy or sell), and a quantity to be bought or sold;
wherein the destination of the order is the one or more destinations selected by said smart router.

30. The electronic trade routing system according to claim 24, wherein the trading clients include one or more from a list consisting of order management systems, execution management systems, and proprietary trading interfaces.

31. The electronic trade routing system according to claim 24, wherein the trade execution venues include one or more from a list consisting of alternative trade system, electronic communication networks, markets, algorithmic trading systems, streaming liquidity systems, negotiated trading systems, and crossing systems.

32. The electronic trade routing system according to claim 28, wherein said electronic trade orders further includes an indication whether the order is qualified for rerouting and wherein said system only reroutes electronic trade orders that bear an indication that the order is qualified for rerouting.

33. The electronic trade routing system according to claim 24, wherein when it is determined that at least a portion of an electronic trade order already routed should be redirected from the designated destination to a new destination, the original electronic trade order transmitted to the designated destination is cancelled and replaced with a new electronic trade order decreased in quantity corresponding to the portion being redirected.
